(19) United States
(12) Patent Application Publication
(10) Pub. No.: US 2006/0152442 A1
(43) Pub. Date: Jul. 13, 2006

(54) Plasma display apparatus and driving method thereof

(75) Inventor: Yong Seok Chi, Suwon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/328,240

(22) Filed: Jan. 10, 2006

(30) Foreign Application Priority Data
Jan. 10, 2005 (KR) 10-2005-0002360

(51) Int. Cl. G09G 3/28

(52) U.S. Cl. 345/60

(57) ABSTRACT

The present invention relates to a plasma display apparatus and driving method thereof. The plasma display apparatus and driving method thereof according to an embodiment of the present invention changes the number of sustain pulses according to a total operating time of a plasma display panel. The plasma display apparatus and driving method thereof according to an embodiment of the present invention can prevent a decrease in luminance and a decrease in the picture quality, which are incurred by an increase in a total operating time.

This Nonprovisional application claims priority under 35 U.S.C. § 119(a) on Patent Application No. 2005-0002360 filed in Korea on Jan. 10, 2005, the entire contents of which are hereby incorporated by reference.

### BACKGROUND OF THE INVENTION

1. Field of the Invention

The present document relates to a plasma display apparatus and driving method thereof.

2. Description of the Background Art

FIG. 1 shows the structure of a general plasma display panel. As shown in FIG. 1, the general plasma display panel has a front panel 100 and a rear panel 110. The front panel 100 has a front glass substrate 101 and the rear panel 110 has a rear glass substrate 111. The front panel 100 and the rear panel 110 are coalesced with a predetermined distance.

A sustain electrode pair for sustaining the emission of a cell through mutual discharge are formed on the front glass substrate 101. The sustain electrode pair has a scan electrode 102 and a sustain electrode 103. The scan electrode 102 has a transparent electrode 102a formed of a transparent ITO material and a bus electrode 102b formed of a metal material. The sustain electrode 103 has a transparent electrode 103a formed of a transparent ITO material and a bus electrode 103b formed of a metal material.

The scan electrode 102 receives a scan signal for scanning the panel and a sustain pulse for sustaining a discharge. The sustain electrode 103 receives a sustain pulse. An upper dielectric layer 104 is formed on the sustain electrode pair, and it functions to limit a discharge current and provides insulation between the electrodes. A protection layer 105 is formed on a top surface of the dielectric layer 104 and is formed of Magnesium Oxide (MgO).

Address electrodes 113 crossing the sustain electrode pair are formed on the rear glass substrate 111. A lower dielectric layer 115 is formed on the address electrodes 113 and functions to provide insulation between the address electrodes 113. Barrier ribs 112 are formed on the dielectric layer 115 and partition discharge cells. Phosphor layers 114 are coated between the barrier ribs 112 and radiate a visible ray for displaying images.

The front glass substrate 101 and the rear glass substrate 111 are coalesced by a sealing material. Inert gases, such as helium (He), neon (Ne) and xeon (Xe), are injected into the plasma display panel after an exhaust process is performed.

A general plasma display apparatus has drivers that supply driving pulses, and a plasma display panel that operates according to the driving pulses.

FIG. 2 is a block diagram showing the construction of a general plasma display apparatus. As shown in FIG. 2, the general plasma display apparatus has a data arrangement unit 200, a timing controller 201, a data driver 202, a scan driver 203 and a sustain driver 204.

The data arrangement unit 200 arranges externally input image data.

The data driver 202 applies the image data, which are arranged by data arrangement unit 200, to address electrodes X1 to Xm under the control of the timing controller 201.

The scan driver 203 applies a scan pulse and a sustain pulse to scan electrodes Y1 to Yn under the control of the timing controller 201.

The sustain driver 204 applies a sustain pulse to a sustain electrode Z under the control of the timing controller 201.

A method of implementing gray levels of an image in the plasma display panel will now be described with reference to FIG. 3.

FIG. 3 is a view illustrating a method of implementing gray levels of an image of a general plasma display panel. As shown in FIG. 3, one frame is divided into several sub-fields and each of the sub-fields is divided into a reset period, an address period and a sustain period. The sustain period is increased in the ratio of 2ⁿ (where n=0, 1, 2, 3, 4, 5, 6, 7) in each sub-field. Since the sustain period is varied every sub-field, gray levels of an image are represented by controlling the sustain period of each sub-field, i.e., a sustain discharge number.

Meanwhile, the general plasma display apparatus is problematic in that luminance of light is gradually attenuated according to an operating time as shown in FIG. 5.

FIGS. 4a and 4b are graphs illustrating a luminance attenuation tendency of a general plasma display apparatus. FIG. 4a shows the luminance attenuation ratio of a full white image pattern when a general plasma display apparatus displays the full white image pattern according to the operating time. FIG. 4b shows the luminance attenuation ratio of a peak white image pattern when a general plasma display apparatus displays the peak white image pattern according to the operating time. An x axis designates the operating time (hr) of the plasma display panel and a y axis designates the luminance attenuation ratio (%).

As shown in FIGS. 4a and 4b, in the general plasma display apparatus, luminance is gradually attenuated according to the operating time. More particularly, as shown in FIG. 4b, the attenuation of luminance is severe when the general plasma display apparatus displays the peak white image pattern. A luminance attenuation phenomenon is generated since phosphors are degraded according to the operating time of the plasma display panel. Accordingly, a problem arises because the picture quality of an image displayed by a plasma display apparatus is worsened.

### SUMMARY OF THE INVENTION

Accordingly, an object of an embodiment of the present invention is to solve at least the problems and disadvantages of the background art.

An embodiment of the present invention is to provide a plasma display apparatus and driving method thereof in which a decrease in luminance depending on an operating time can be prevented.

Another embodiment of the present invention is to provide a plasma display apparatus and driving method thereof in which a decrease in the picture quality depending on an operating time can be prevented.

A plasma display apparatus according to an aspect of the present invention comprises a sustain pulse controller that outputs a pulse number signal for controlling the number of sustain pulses according to a total operating time, a timing controller that receives the pulse number signal from the sustain pulse controller and outputs a timing signal for outputting a sustain pulse corresponding to the pulse number signal, an electrode driver that outputs a sustain pulse according to the timing signal received from the timing controller, and a plasma display panel comprising electrodes, that receives the sustain pulse from the electrode driver through the electrodes and displays images.

A plasma display apparatus according to another aspect of the present invention comprises an operating time detector that outputs a time information signal depending on a total operating time, a power controller that outputs a weight signal corresponding to a weight of a sustain pulse number according to the time information signal received from the operating time detector, a sustain pulse number decision unit that outputs a pulse number signal corresponding to the number of sustain pulses according to the weight signal received from the power controller, a timing controller that outputs a timing signal for outputting a sustain pulse corresponding to the pulse number signal received from the sustain pulse number decision unit, an electrode driver that outputs a sustain pulse according to the timing signal received from the timing controller, and a plasma display panel comprising electrodes, that receives the sustain pulse from the electrode driver through the electrodes and displays images.

A method of driving a plasma display apparatus according to another aspect of the present invention comprises the steps of calculating a total operating time and outputting a time information signal depending on the total operating time, outputting a weight signal corresponding to a weight of a sustain pulse number according to the time information signal, outputting a pulse number signal corresponding to the number of sustain pulses depending on the weight signal, outputting a timing signal for outputting a sustain pulse corresponding to the pulse number signal, and outputting a sustain pulse to electrodes according to the timing signal.

The plasma display apparatus and driving method thereof according to another embodiment of the present invention can prevent a decrease in luminance depending on an operating time.

The plasma display apparatus and driving method thereof according to an embodiment of the present invention can prevent a decrease in the picture quality depending on an operating time.

### BRIEF DESCRIPTION OF THE DRAWINGS

The embodiment of the invention will be described in detail with reference to the following drawings in which like numerals refer to like elements.

FIG. 1 shows the structure of a general plasma display panel;

FIG. 2 is a block diagram showing the construction of a general plasma display apparatus;

FIG. 3 is a view illustrating a method of implementing gray levels of an image of a general plasma display panel;

FIGS. 4a and 4b are graphs illustrating a luminance attenuation tendency of a general plasma display apparatus;

FIG. 5 is a block diagram showing the construction of a plasma display apparatus according to an embodiment of the present invention;

FIG. 6 shows an embodiment of a sustain pulse controller according to an embodiment of the present invention;

FIG. 7 is a graph illustrating a power characteristic curve for deciding the number of sustain pulses depending on a weight of a sustain pulse number according to an embodiment of the present invention;

FIG. 8 is a flowchart illustrating a method of operating an operating time detector according to an embodiment of the present invention; and

FIG. 9 is a flowchart illustrating the operation of the plasma display apparatus according to an embodiment of the present invention.

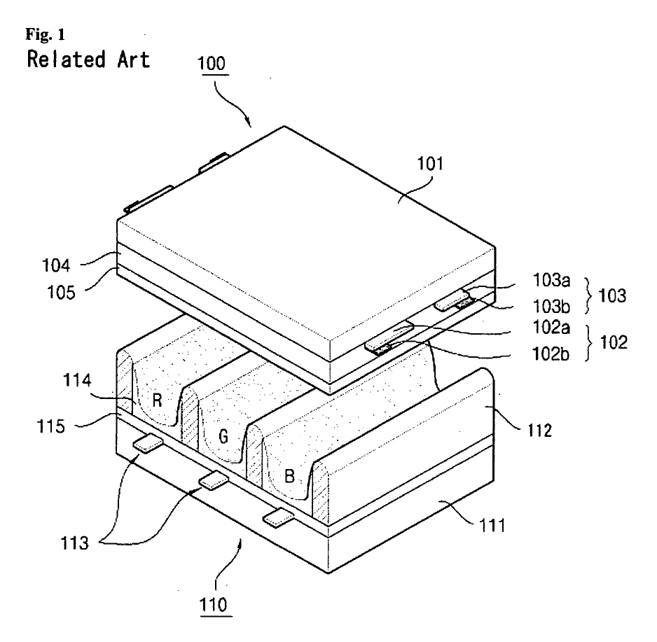

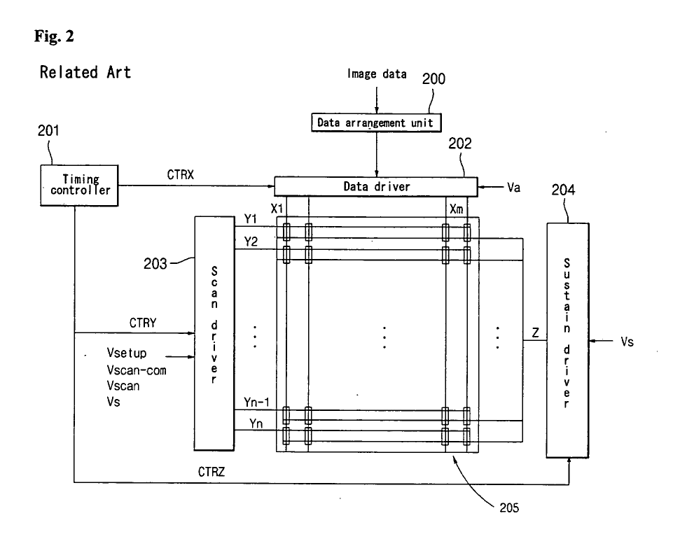

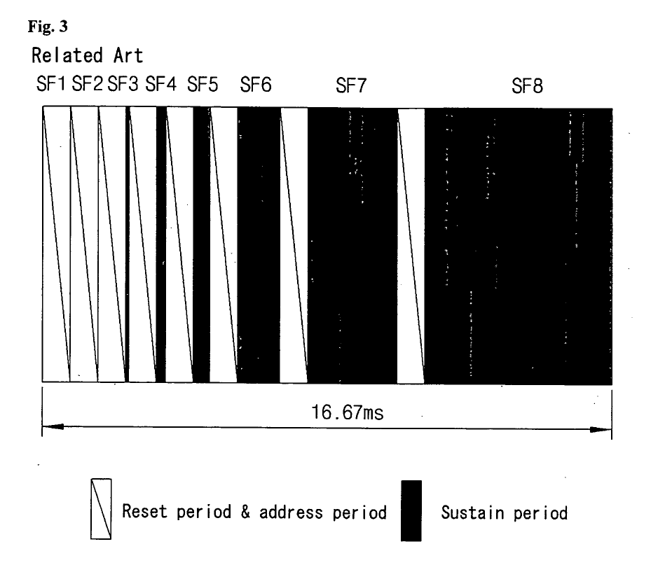

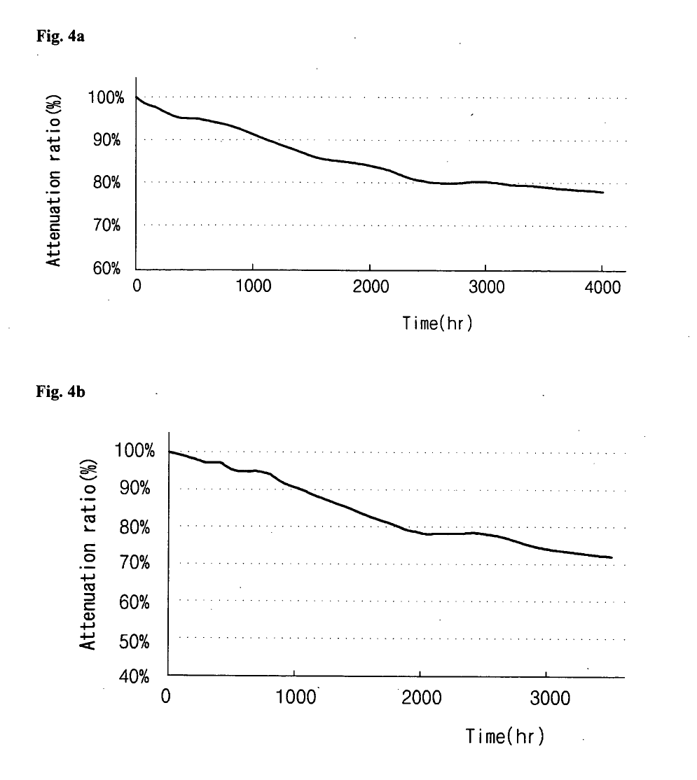

### DETAILED DESCRIPTION OF PREFERRED EMBODIMENTS

Embodiments of the present invention will be described in a more detailed manner with reference to the drawings.

A plasma display apparatus according to an aspect of the present invention comprises a sustain pulse controller that outputs a pulse number signal for controlling the number of sustain pulses according to a total operating time, a timing controller that receives the pulse number signal from the sustain pulse controller and outputs a timing signal for outputting a sustain pulse corresponding to the pulse number signal, an electrode driver that outputs a sustain pulse according to the timing signal received from the timing controller, and a plasma display panel comprising electrodes, for receiving the sustain pulse from the electrode driver through the electrodes and displaying images.

The sustain pulse controller may output a pulse number signal for increasing the number of sustain pulses as the total operating time increases.

The sustain pulse controller may calculate the total operating time by accumulating an operating time that has been calculated beginning from when the electrode driver supplies a sustain voltage.

The sustain pulse controller may calculate the total operating time by accumulating an operating time that has been calculated beginning from when power is supplied.

The sustain pulse controller may output a pulse number signal for increasing the number of sustain pulses allocated to the sustain periods of all of the sub-fields as the total operating time increases.

The sustain pulse controller may output a pulse number signal for increasing the number of sustain pulses allocated to the sustain periods of one or more of the sub-fields as the total operating time increases.

A plasma display apparatus according to another aspect of the present invention comprises an operating time detector that outputs a time information signal depending on a total operating time, a power controller that outputs a weight signal corresponding to a weight of a sustain pulse number according to the time information signal received from the operating time detector, a sustain pulse number decision unit that outputs a pulse number signal corresponding to the number of sustain pulses according to the weight signal received from the power controller, a timing controller that outputs a timing signal for outputting a sustain pulse corresponding to the pulse number signal received from the sustain pulse number decision unit, an electrode driver that outputs a sustain pulse according to the timing signal received from the timing controller, and a plasma display panel comprising electrodes, that receives the sustain pulse from the electrode driver through the electrodes and displays images.

The operating time detector may calculate the total operating time by accumulating an operating time that has been calculated beginning from when the electrode driver supplies a sustain voltage.

The operating time detector may calculate the total operating time by accumulating an operating time that has been calculated beginning from when power is supplied.

The power controller may comprise a power control look-up table for deciding the weight of the sustain pulse number depending on the total operating time.

The power controller may increase the weight of the sustain pulse number as the total operating time increases.

The weight of the sustain pulse number may be a weight of a sustain pulse number supplied in a sustain period of at least one of the sub-fields.

The weight of the sustain pulse number may be a weight of the whole sustain pulse number supplied in one frame period.

The sustain pulse number decision unit may comprise a pulse number look-up table for deciding the number of sustain pulses depending on the weight of the sustain pulse number.

A method of driving a plasma display apparatus according to another aspect of the present invention comprises the steps of calculating a total operating time and outputting a time information signal depending on the total operating time, outputting a weight signal corresponding to a weight of a sustain pulse number according to the time information signal, outputting a pulse number signal corresponding to the number of sustain pulses depending on the weight signal, outputting a timing signal for outputting a sustain pulse corresponding to the pulse number signal, and outputting a sustain pulse to electrodes according to the timing signal.

The weight of the sustain pulse number may increases as the total operating time increases.

The weight of the sustain pulse number may be a weight of a sustain pulse number supplied in a sustain period of at least one of the sub-fields.

The weight of the sustain pulse number may be a weight of the whole sustain pulse number supplied in one frame period.

The total operating time may be calculated by accumulating an operating time that has been calculated beginning from when a sustain voltage is supplied.

The total operating time may be calculated by accumulating an operating time that has been calculated beginning from when power is supplied.

Hereinafter, a detailed embodiment of the present invention will be described with reference to the accompanying drawings.

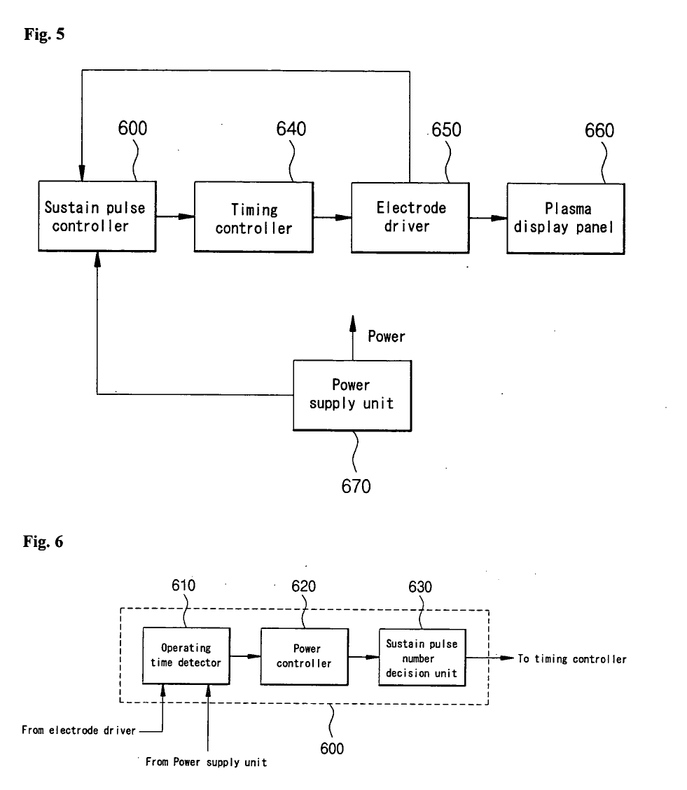

FIG. 5 is a block diagram showing the construction of a plasma display apparatus according to an embodiment of the present invention. As shown in FIG. 5, the plasma display apparatus of the present invention comprises a sustain pulse controller 600, a timing controller 640, an electrode driver 650 and a plasma display panel 660.

The sustain pulse controller 600 outputs a pulse number signal for controlling the number of sustain pulses according to a total operating time of the plasma display panel 660. The sustain pulse controller 600 outputs a pulse number signal for increasing number of sustain pulses as a total operating time increases.

The timing controller 640 receives the pulse number signal from the sustain pulse controller 600 and outputs a timing signal for outputting a sustain pulse corresponding to the pulse number signal.

The electrode driver 650 outputs a sustain pulse according to the timing signal received from the timing controller 640.

The plasma display panel 660 comprises electrodes and is supplied with the sustain pulse from the electrode driver 650, thus displaying images through the electrodes.

The sustain pulse controller 600 can calculate a total operating time by accumulating an operating time that is calculated beginning from when the electrode driver 650 supplies a sustain voltage for sustaining the discharge of a discharge cell. Furthermore, the sustain pulse controller 600 can calculate a total operating time by accumulating an operating time that is calculated beginning from when a power supply unit 670 supplies power.

The plasma display apparatus according to an embodiment of the present invention increases the number of sustain pulses allocated to a sustain period of a subfield in order to compensate for the luminance of the plasma display panel, which is attenuated as the operating time of the plasma display panel increases.

The sustain pulse controller 600 can output a pulse number signal for increasing the number of sustain pulses allocated to the sustain periods of all of the sub-fields as a total operating time of the plasma display panel increases, or can output a pulse number signal for increasing the number of sustain pulses allocated to sustain periods of one or more of the sub-fields.

FIG. 6 shows an embodiment of a sustain pulse controller according to an embodiment of the present invention. In the embodiment of the sustain pulse controller 600, a number weight of sustain pulses is increased in order to increase the number of sustain pulses as a total operating time of a plasma display panel is increased.

The sustain pulse controller 600 according to an embodiment of the present invention comprises an operating time detector 610, a power controller 620 and a sustain pulse number decision unit 630.

The operating time detector 610 detects an operating time of the plasma display panel, sums a previous operating time and a current operating time to produce a total operating time, and outputs a time information signal depending on the total operating time. The operating time detector 610 can calculate a total operating time by accumulating an operating time that has been calculated beginning from when the electrode driver 650 of FIG. 5 supplies a sustain voltage for sustaining the discharge of a discharge cell. Furthermore, the operating time detector 610 can calculate a total operating time by accumulating an operating time that has been calculated beginning from when the power supply unit 670 supplies power.

The power controller 620 outputs a weight signal corresponding to a weight of a sustain pulse number according to the time information signal received from the operating time detector 610. The power controller 620 comprises a power control look-up table in order to decide a weight of a sustain pulse number depending on a total operating time. Furthermore, the power controller 620 increases the weight of the sustain pulse number as the total operating time increases. The weight of the sustain pulse number can be a weight of a sustain pulse number supplied in a sustain period of at least one of the sub-fields, or can be a weight of the whole sustain pulse number supplied in one frame period.

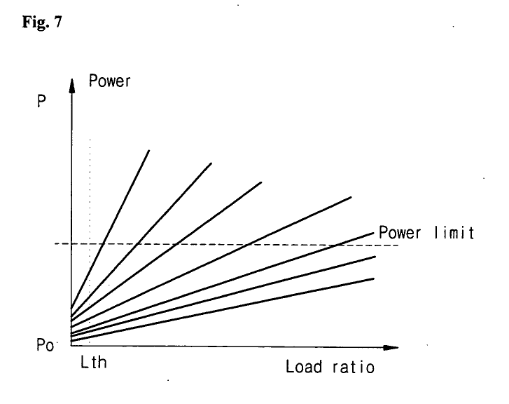

The sustain pulse number decision unit 630 receives the weight signal from the power controller 620 and outputs a pulse number signal corresponding to the number of a sustain pulse depending on the weight of the sustain pulse number. The sustain pulse number decision unit 630 comprises a pulse number look-up table in order to decide number of sustain pulses depending on a weight of a sustain pulse number. That is, the sustain pulse number decision unit 630 receives a modify flag signal in order to modify the sustain pulse number depending on variations in weight and modifies the pulse number look-up table. The sustain pulse number depending 6n the weight of the sustain pulse number can be decided according to a power characteristic curve of FIG. 7.

FIG. 7 is a graph illustrating a power characteristic curve for deciding the number of sustain pulses depending on a weight of a sustain pulse number according to an embodiment of the present invention. Parameters shown in FIG. 7 are as follows.

A load ratio is an Average Picture Level (APL) of the screen displayed every frame. Lth is a reference APL value. A power limit is a limit value of power supplied to the plasma display panel.

In the power characteristic curve of FIG. 7, the power (P) is linearlly proportional to the load ratio (L). Therefore, the relationship between the power (P) and the load ratio (L) can be expressed in the following Equation 1.
P=Po+a*L [Equation 1]

Po is power where L=0%.

P is proportional to the number of a sustain pulses (Ns). Therefore, if “Po” and “a” of Equation 1 is converted into the function of Ns, it results in the following Equation 2.
P=f(Ns,L)=Po(Ns)+a(Ns)*L=(A+B*Ns)+(C+D*Ns)*L [Equation 2]

“A, “B”, “C” and “D” are constants. The number of sustain pulses depending on the load ratio (L) can be calculated using the weight of a sustain pulse number depending on a total operating time of the plasma display panel and a power-value as shown in Equation 2 and the following Table 1.

TABLE 1

| Total Operating Time | Weight | Consumption Power |
|---|---|---|
| 0 Hour-500 Hour | 100% | 220 W-270 W |
| 500 Hour-1000 Hour | 120% | 240 W-280 W |
| 1000 Hour-1500 Hour | 140% | 260 W-300 W |
| 1500 Hour-2000 Hour | 160% | 280 W-320 W |

The weight of the sustain pulse number depending on a total operating time of the plasma display panel and the power value can be varied, if appropriate.

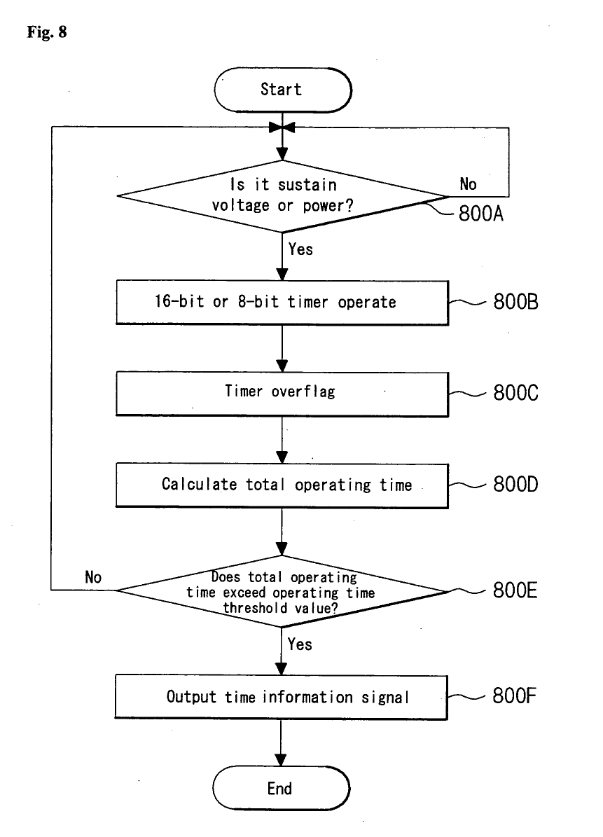

FIG. 8 is a flowchart illustrating a method of operating an operating time detector according to an embodiment of the present invention.

The operating time detector 610 of FIG. 6 determines whether the electrode driver 650 of FIG. 5 applies a sustain voltage (Vs) (800A). The operating time detector 610 may determine whether the power supply unit 670 of FIG. 5 supplies power.

If the sustain voltage or power is applied, a 16-bit or 8-bit timer (not shown) of the operating time detector 610 operates (800B).

The timer generates an over flag if a predetermined time elapses (800C).

The timer calculates a total operating time that has been accumulated from the first operation of the plasma display panel to the current by adding the over flag and an operating time that has been accumulated (800D).

The operating time detector 610 determines whether a current total operating time is greater than a preset operating time threshold value (800E). In Table 1, the operating time threshold value is 500 hours, and can be set to range 400 to 600 hours.

If it is determined that the current total operating time is greater than the operating time threshold value, the operating time detector 610 outputs a time information signal for controlling the number of sustain pulses to the power controller 620 of FIG. 6 (800F).

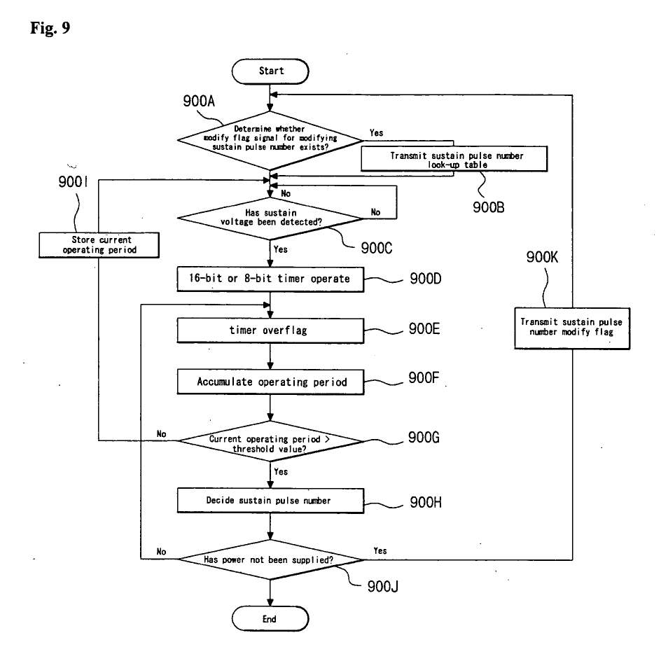

FIG. 9 is a flowchart illustrating the operation of the plasma display apparatus according to an embodiment of the present invention.

If the power supply unit 670 of FIG. 5 begins supplying power, the timing controller 640 determines whether a modify flag signal for modifying a sustain pulse number exists (900A).

If it is determined that the flag signal exists, the sustain pulse number decision unit 630 of FIG. 6 transmits the sustain pulse number look-up table for increasing the number of the sustain pulses according to variations in weight to the timing controller 640 and outputs a timing signal (900B).

The operating time detector 610 of FIG. 6 determines whether the electrode driver 650 of FIG. 5 applies the sustain voltage (Vs). The operating time detector 610 can determine whether the power supply unit 670 of FIG. 5 supplies power (900C).

If the sustain voltage or power is supplied, the 16-bit or 8-bit timer (not shown) of the operating time detector 610 operates (900D).

If a predetermined time elapses, the timer generates an over flag (900E).

The timer calculates a total operating time that has been accumulated from the first operation of the plasma display panel to the current by adding the over flag and an operating time that has been accumulated (900F).

The operating time detector 610 determines whether a current total operating time is greater than a preset operating time threshold value (900G). In Table 1, the operating time threshold value is 500 hours, and can be set to range 400 to 600 hours.

If it is determined that the operating time is greater than the threshold value, the number of sustain pulses is decided through the power controller 620 and the sustain pulse number decision unit 630, and the timing controller 640 outputs a timing signal for supplying a sustain pulse (900H). Therefore, a decrease in luminance depending on an increase of an operating time can be compensated for. The power controller 620 increases a weight of a sustain pulse number as a total operating time increases. The weight of the sustain pulse number can be a weight of a sustain pulse number supplied in a sustain period of at least one of the sub-fields, or can be a weight of the whole sustain pulse number supplied in one-frame period.

If it is determined that the operating time is smaller than the threshold value, the operating time that has been accumulated so far is stored, and the process returns to the process of determining whether the operation of the plasma display panel exists (900I).

The operating time detector 610 determines whether power has been supplied from the power supply unit 670 (900J).

If it is determined that power has not been supplied, a modify flag of the sustain pulse number is stored (900K). Meanwhile, if it is determined that power has been supplied, the process returns to the process where the timer generates the over flag (900E).

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a sustain pulse controller that outputs a pulse number signal for controlling the number of sustain pulses according to a total operating time;
a timing controller that receives the pulse number signal from the sustain pulse controller and outputs a timing signal for outputting a sustain pulse corresponding to the pulse number signal;
an electrode driver that outputs a sustain pulse according to the timing signal received from the timing controller; and
a plasma display panel comprising electrodes, that receives the sustain pulse from the electrode driver through the electrodes and displays images.

2. The plasma display apparatus as claimed in claim 1, wherein the sustain pulse controller outputs a pulse number signal for increasing the number of sustain pulses as the total operating time increases.

3. The plasma display apparatus as claimed in claim 1, wherein the sustain pulse controller calculates the total operating time by accumulating an operating time that has been calculated beginning from when the electrode driver supplies a sustain voltage.

4. The plasma display apparatus as claimed in claim 1, wherein the sustain pulse controller calculates the total operating time by accumulating an operating time that has been calculated beginning from when power is supplied.

5. The plasma display apparatus as claimed in claim 1, wherein the sustain pulse controller outputs a pulse number signal for increasing the number of sustain pulses allocated to the sustain periods of all of the sub-fields as the total operating time increases.

6. The plasma display apparatus as claimed in claim 1, wherein the sustain pulse controller outputs a pulse number signal for increasing the number of sustain pulses allocated to the sustain periods of one or more of the sub-fields as the total operating time increases.

7. A plasma display apparatus comprising:
an operating time detector that outputs a time information signal depending on a total operating time;
a power controller that outputs a weight signal corresponding to a weight of a sustain pulse number according to the time information signal received from the operating time detector;
a sustain pulse number decision unit that outputs a pulse number signal corresponding to the number of sustain pulses according to the weight signal received from the power controller;
a timing controller that outputs a timing signal for outputting a sustain pulse corresponding to the pulse number signal received from the sustain pulse number decision unit;
an electrode driver that outputs a sustain pulse according to the timing signal received from the timing controller; and
a plasma display panel comprising electrodes, that receives the sustain pulse from the electrode driver through the electrodes and displays images.

8. The plasma display apparatus as claimed in claim 7, wherein the operating time detector, calculates the total operating time by accumulating an operating time that has been calculated beginning from when the electrode driver supplies a sustain voltage.

9. The plasma display apparatus as claimed in claim 7, wherein the operating time detector calculates the total operating time by accumulating an operating time that has been calculated beginning from when power is supplied.

10. The plasma display apparatus as claimed in claim 7, wherein the power controller comprises a power control look-up table for deciding the weight of the sustain pulse number depending on the total operating time.

11. The plasma display apparatus as claimed in claim 7, wherein the power controller increases the weight of the sustain pulse number as the total operating time increases.

12. The plasma display apparatus as claimed in claim 11, wherein the weight of the sustain pulse number is a weight of a sustain pulse number supplied in a sustain period of at least one of the sub-fields.

13. The plasma display apparatus as claimed in claim 11, wherein the weight of the sustain pulse number is a weight of the whole sustain pulse number supplied in one frame period.

14. The plasma display apparatus as claimed in claim 11, wherein the sustain pulse number decision unit comprises a pulse number look-up table for deciding the number of sustain pulses depending on the weight of the sustain pulse number.

15. A method of driving a plasma display apparatus, comprising the steps of:
calculating a total, operating time and outputting a time information signal depending on the total operating time;
outputting a weight signal corresponding to a weight of a sustain pulse number according to the time information signal;
outputting a pulse number signal corresponding to the number of sustain pulses depending on the weight signal;
outputting a timing signal for outputting a sustain pulse corresponding to the pulse number signal; and
outputting a sustain pulse to electrodes according to the timing signal.

16. The method as claimed in claim 15, wherein the weight of the sustain pulse number increases as the total operating time increases.

17. The method as claimed in claim 16, wherein the weight of the sustain pulse number is a weight of a sustain pulse number supplied in a sustain period of at least one of the sub-fields.

18. The method as claimed in claim 16, wherein the weight of the sustain pulse number is a weight of the whole sustain pulse number supplied in one frame period.

19. The method as claimed in claim 15, wherein the total operating time is calculated by accumulating an operating time that has been calculated beginning from when a sustain voltage is supplied.

20. The method as claimed in claim 15, wherein the total operating time is calculated by accumulating an operating time that has been calculated beginning from when power is supplied.
